(19) United States
(12) Patent Application Publication
(10) Pub. No.: US 2025/0044931 A1
(43) Pub. Date: Feb. 6, 2025

(54) PAGE CONTROL METHOD, APPARATUS AND DEVICE, AND STORAGE MEDIUM

(71) Applicant: Beijing Zitiao Network Technology Co., Ltd., Beijing (CN)

(72) Inventor: Cong PENG, Beijing (CN)

(21) Appl. No.: 18/720,592

(22) PCT Filed: Dec. 30, 2022
(86) PCT No.: PCT/CN2022/143798

§ 371 Date: Jun. 14, 2024

(30) Foreign Application Priority Data
Jan. 17, 2022 (CN) 202210050738.3

(51) Int. Cl. G06F 3/0488; G06F 3/0483; G06F 3/0484

(52) U.S. Cl. CPC G06F 3/0488; G06F 3/0483; G06F 3/0484; G06F 2203/04806

(57) ABSTRACT

Provided in the present disclosure are a page control method, apparatus and device, and a storage medium. The method includes: in response to detecting a touch starting event for a preset control on a video playing page, presenting a display effect for the preset control on the basis of the time difference between a time stamp of the touch starting event and the current time stamp, and presenting an interaction display effect for a played target video; and in response to detecting a touch ending event, if it is determined that the time difference between the touch starting event and the touch ending event is not less than a preset duration threshold value, jumping to a preset page corresponding to the target video.

### CROSS-REFERENCE TO RELATED APPLICATIONS

The present application is based on and claims the priority to the Chinese application No. 202210050738.3 entitled “PAGE CONTROL METHOD, APPARATUS AND DEVICE, AND STORAGE MEDIUM” filed on Jan. 17, 2022, the disclosure of which is incorporated by reference herein in its entirety.

### TECHNICAL FIELD

The present disclosure relates to the field of information processing, and in particular, to a page control method, apparatus and device, and a storage medium.

### BACKGROUND

With the continuous development of information technology, an application can achieve more and more functions, but consequently also bring some bad experience problems to users. For example, when a user starts the application, a splash advertisement will be played, and if the user is not interested in the splash advertisement, the user will choose to skip the splash advertisement and directly enter a home page of the application. However, due to a mis-touch of the user on a screen and the like, the user who is not interested in the splash advertisement enters a landing page for the splash advertisement, thereby bringing bad use experience to the user.

Therefore, how to reduce experience problems due to the mis-touch on the screen is a technical problem to be solved urgently at present.

### SUMMARY

In order to solve the above technical problem, the present disclosure provides a page control method.

In a first aspect, the present disclosure provides a page control method, comprising:
in response to detecting a touch starting event for a preset control on a video playing page, on the basis of a touch duration corresponding to the touch starting event, performing display effect presentation for the preset control on the video playing page, and performing interaction effect presentation for a target video played on the video playing page, wherein the touch duration corresponding to the touch starting event comprises a time difference between a timestamp when the touch starting event is detected and a current timestamp;
in response to detecting a touch ending event corresponding to the touch starting event, determining whether a time difference between the touch starting event and the touch ending event is less than a preset duration threshold; and in response to determining that the time difference between the touch starting event and the touch ending event is not less than the preset duration threshold, jumping from the video playing page to a preset page corresponding to the target video.

In a second aspect, the present disclosure provides a page control apparatus, comprising:
a presentation module configured to, in response to detecting a touch starting event for a preset control on a video playing page, on the basis of a touch duration corresponding to the touch starting event, perform display effect presentation for the preset control on the video playing page, and perform interaction effect presentation for a target video played on the video playing page, wherein the touch duration corresponding to the touch starting event comprises a time difference between a timestamp when the touch starting event is detected and a current timestamp;
a determination module configured to, in response to detecting a touch ending event corresponding to the touch starting event, determine whether a time difference between the touch starting event and the touch ending event is less than a preset duration threshold; and
a jump module configured to, in response to determining that the time difference between the touch starting event and the touch ending event is not less than the preset duration threshold, jump from the video playing page to a preset page corresponding to the target video.

In a third aspect, the present disclosure provides a computer-readable storage medium having stored therein instructions that, when run on a terminal device, cause the terminal device to implement the method described above.

In a fourth aspect, the present disclosure provides a page control device, comprising: a memory, a processor, and a computer program stored on the memory and executable on the processor, the processor, when executing the computer program, implementing the method described above.

In a fifth aspect, the present disclosure provides a computer program product, comprising computer programs/instructions which, when executed by a processor, implement the method described above.

In a sixth aspect, the present disclosure provides a computer program, comprising: instructions which, when executed by a processor, cause the processor to perform any of the page control methods according to the embodiments of the present disclosure.

### BRIEF DESCRIPTION OF THE DRAWINGS

The accompanying drawings herein, which are incorporated in and constitute a part of this specification, illustrate embodiments consistent with the present disclosure and, together with the description, serve to explain the principles of the present disclosure.

In order to more clearly illustrate technical solutions in the embodiments of the present disclosure or the related art, the drawings that need to be used in the description of the embodiments or the related art will be briefly described below, and it is obvious that for those skilled in the art, other drawings can also be obtained without paying creative labor.

FIG. 1 is a flowchart of a page control method according to an embodiment of the present disclosure;

FIG. 2 is a schematic diagram of a preset control display according to an embodiment of the present disclosure;

FIG. 3 is a schematic diagram of another preset control display according to an embodiment of the present disclosure;

FIG. 4 is a schematic diagram of a video playing page according to an embodiment of the present disclosure;

FIG. 5 is a schematic structural diagram of a page control apparatus according to an embodiment of the present disclosure;

FIG. 6 is a schematic structural diagram of a page control device according to an embodiment of the present disclosure.

### DETAILED DESCRIPTION

In order that the above objectives, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be implemented in other ways different from those described herein; and it is obvious that the embodiments in the description are only part of the embodiments of the present disclosure, rather than all of them.

With the continuous development of information technology, an application can achieve more and more functions, but consequently also bring some bad experience problems to users. For example, when a user starts the application, a splash advertisement will be played, and if the user is not interested in the splash advertisement, the user will choose to skip the splash advertisement and directly enter a home page of the application. However, due to a mis-touch of the user on a screen and the like, the user who is not interested in the splash advertisement enters a landing page for the splash advertisement, thereby bringing bad use experience to the user.

Therefore, how to reduce experience problems due to the mis-touch on the screen is a technical problem to be solved urgently at present.

In order to reduce the experience problems caused by the mis-touch on the screen, an embodiment of the present disclosure provides a page control method, comprising: first, in response to detecting a touch starting event for a preset control on a video playing page, on the basis of a touch duration corresponding to the touch starting event, performing display effect presentation for the preset control on the video playing page, and performing interaction effect presentation for a target video played on the video playing page, wherein the touch duration corresponding to the touch starting event comprises a time difference between a timestamp when the touch starting event is detected and a current timestamp; then, in response to detecting a touch ending event corresponding to the touch starting event, determining whether a time difference between the touch starting event and the touch ending event is less than a preset duration threshold; and in response to determining that the time difference between the touch starting event and the touch ending event is not less than the preset duration threshold, jumping from the video playing page to a preset page corresponding to the target video.

It can be seen that, according to the embodiment of the present disclosure, when the touch duration of the user on the preset control on the video playing page reaches the preset duration threshold, it is able to control page jump; in addition, before the touch ending event is received, by performing the effect display for the preset control on the basis of the touch duration corresponding to the touch starting event and performing interaction effect presentation for the target video, it is able to not only reduce the experience problems caused by the mis-touch on the screen, but also improve the user interaction experience by feeding back the touch effect to the user.

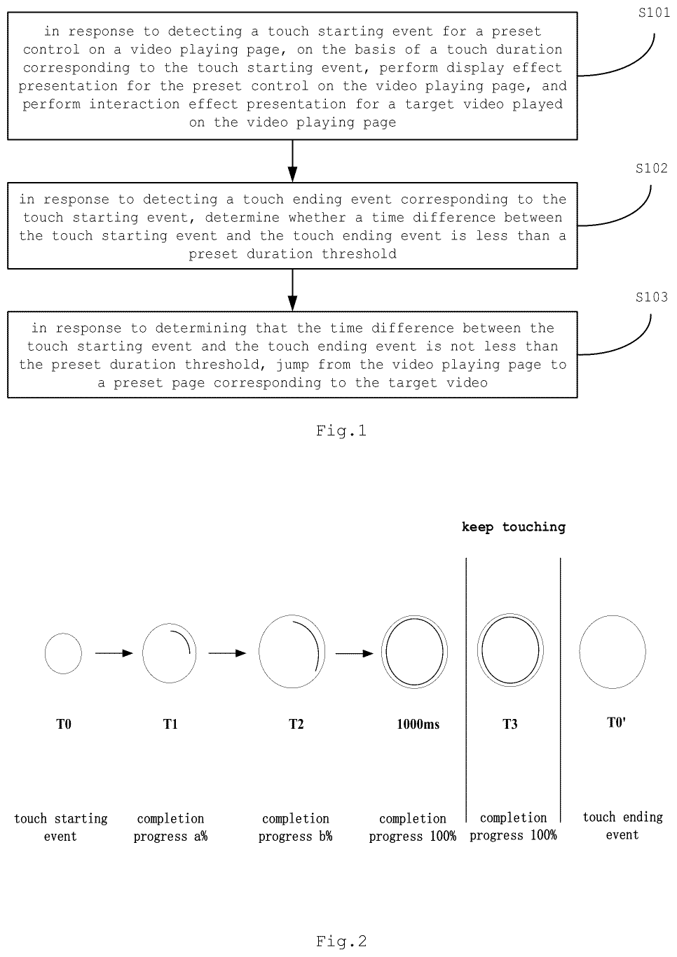

Based on this, an embodiment of the present disclosure provides a page control method. Reference is made to FIG. 1, which is a flowchart of a page control method according to an embodiment of the present disclosure, comprising:
S101: in response to detecting a touch starting event for a preset control on a video playing page, on the basis of a touch duration corresponding to the touch starting event, performing display effect presentation for the preset control on the video playing page, and performing interaction effect presentation for a target video played on the video playing page.

The touch duration corresponding to the touch starting event comprises a time difference between a timestamp when the touch starting event is detected and a current timestamp.

The embodiment of the present disclosure is applied to a smart terminal having a touchable screen, which may comprise, for example, a smart phone having a touchable screen, a tablet having a touchable screen, and the like.

In the embodiment of the present disclosure, the video playing page is thereon provided with a preset control, wherein the preset control can be provided at any position on the video playing page, and the preset control can also be in any shape. For example, the preset control may be provided in a middle position, a directly below position, a right middle position, and the like on the video playing page, and the preset control may be a semi-transparent circle control, square control, and the like; after a touch starting event triggered for the preset control on the video playing page is detected, display effect presentation for the preset control on the video playing page may be performed on the basis of a touch duration corresponding to the touch starting event.

In the embodiment of the present disclosure, the touch starting event may refer to an event corresponding to an operation that a finger touches the preset control on the video playing page. In response to detecting the touch starting event for the preset control on the video playing page, timekeeping is started, wherein a corresponding timestamp when it is detected that the finger touches the preset control on the video playing page is a start timestamp, and the touch duration corresponding to the touch starting event comprises a time difference between the start timestamp and a current timestamp. For example, assuming that the corresponding timestamp when it is detected that the finger touches the preset control on the video playing page is TO, and the current timestamp is T1, then the touch duration corresponding to the touch starting event is a time difference between TO and T1 (i.e., T1−T0).

In the embodiment of the present disclosure, the touch duration corresponding to the touch starting event is determined, and on the basis of the touch duration corresponding to the touch starting event, the preset control on the video playing page is displayed, wherein the displaying the preset control may comprise performing one or more of: displaying a color of the preset control, which is gradually darkened; displaying a size of the preset control, which is gradually zoomed-in; and displaying a progress bar on the preset control, or the like. The touch duration corresponding to the touch starting event is different, then the display effect of the preset control on the video playing page is different; after the touch duration corresponding to the touch starting event reaches a preset duration threshold (such as 1000 milliseconds), the display effect of the preset control on the video playing page can also be unchanged as the touch duration increases, to prompt a user that a page jump condition has been reached currently, and at this time, by triggering a touch ending event, page jump can be realized.

For example, taking an example that the preset control on the video playing page is a circle control, it is assumed that a touch duration A corresponding to the touch starting event is T1−T0, and a touch duration B corresponding to the touch starting event is T2−T0, wherein the touch duration A is less than the touch duration B. On the basis of the different touch durations A and B, display effects of the preset control on the video playing page are different; for example, on the basis of the touch duration A, a diameter of the displayed circle control is a, and on the basis of the touch duration B, the diameter of the displayed circle control is b, wherein the diameter b is greater than the diameter of a, so that a display effect of gradually zooming-in the size of the circle control is realized.

Assuming that a touch duration C corresponding to the touch starting event is 300 milliseconds, on the basis of the touch duration C, the diameter of the displayed circle control reaches a preset maximum (such as the diameter c); when a touch duration D corresponding to the touch starting event is a value greater than 300 milliseconds, on the basis of the touch duration D, the diameter of the displayed circle control is still the maximum diameter C.

In some embodiments, in response to detecting the touch starting event for the preset control on the video playing page, a ratio of the touch duration corresponding to the touch starting event to the preset duration threshold may be determined according to a preset frequency. Then, on the basis of the ratio, a progress bar is displayed on the preset control on the video playing page. The progress bar is used for characterizing the progress of the touch duration of touching the preset control; if the progress bar is displayed as 100%, this indicates that the touch duration for the preset control reaches the preset duration threshold, and at the time, by ending the touch, a preset page can be jumped to.

A length of the progress bar is in direct proportion to the ratio, and a maximum length of the progress bar corresponds to the ratio of 1.

In the embodiment of the present disclosure, in response to detecting a touch starting event for a preset control on a video playing page, timekeeping is started, and a start timestamp corresponding to the touch starting event is recorded, a difference between the start timestamp and a current timestamp is determined, so as to determine a touch duration corresponding to the touch starting event, and then, a ratio of the touch duration to a preset duration threshold is determined, wherein the preset duration threshold is preset, for limiting a minimum standard duration requirement for the touch duration corresponding to the touch starting event, for example, the preset duration threshold may be 1000 ms (milliseconds), 2000 ms, and the like.

In the embodiment of the present disclosure, on the basis of the ratio of the touch duration corresponding to the touch starting event to the preset duration threshold, a progress bar is displayed on the preset control on the video playing page. The progress bar may be displayed according to a shape of the preset control, for example, if the preset control is a circle control, the display process of the progress bar can be a process from a non-closed circle to a closed circle; if the preset control is a square control, the display process of the progress bar can be a process from a non-closed square to a closed square; and so on. The display shape of the progress bar may also be unassociated with the shape of the preset control, for example, the progress bar is displayed in a form of a number of 0% to 100% above the preset control.

In the embodiment of the present disclosure, the ratio of the touch duration corresponding to the touch starting event to the preset duration threshold is in direct proportion to a display length of the progress bar, and a maximum length of the progress bar corresponds to the ratio of 1. For example, if the ratio of the touch duration to the preset duration threshold is a, the display length of the progress bar is a length corresponding to the ratio of a, and a completion progress corresponding to the progress bar may be a percentage corresponding to the ratio of a; if the ratio of the touch duration to the preset duration threshold is 1, the display length of the progress bar is a length corresponding to the ratio of 1 and is also a maximum length of the progress bar, a completion progress corresponding to the progress bar can be 100%, and at the time, vibration or a sound effect can be accompanied to prompt the user that the touch duration has reached the standard; if the ratio of the touch duration to the preset duration threshold is greater than 1, the display length of the progress bar is still the length corresponding to the ratio of 1, the progress bar is kept in the form of the maximum length, and a completion progress corresponding to the progress bar is 100%.

As shown in FIG. 2, it is a schematic diagram of a preset control display according to an embodiment of the present disclosure, where a preset control is a circle control, and a progress bar is displayed inside the circle control in a non-closed to closed form. Referring to FIG. 2, in response to detecting a touch starting event for a preset control on a video playing page, a corresponding start timestamp is TO (for example, TO is Oms); assuming that a current timestamp is T1, a touch duration A corresponding to the touch starting event is T1−T0, and a ratio a of the touch duration A to a preset duration threshold (for example, 1000 ms) is determined as (T1−T0)/1000, a length of the progress bar displayed on the preset control on the basis of the ratio a is a length corresponding to the ratio of a, and a completion progress corresponding to the progress bar may be a percentage corresponding to the ratio of a; assuming that a current timestamp is T2, a touch duration B corresponding to the touch starting event is T2−T0, and a ratio of b of the touch duration B to the preset duration threshold (e.g., 1000 ms) is determined as (T2−T0)/1000, a length of the progress bar displayed on the preset control on the basis of the ratio of b is a length corresponding to the ratio of b, and a completion progress corresponding to the progress bar may be a percentage corresponding to the ratio of b; assuming that a current timestamp is 1000 ms, a touch duration C corresponding to the touch starting event is 1000 ms, and a ratio of c of the touch duration C to the preset duration threshold (for example, 1000 ms) is determined as 1, a length of the progress bar displayed on the preset control on the basis of the ratio c=1 is a maximum length of the progress bar, and a completion progress corresponding to the progress bar is 100%; assuming that a current timestamp is T3 (T3 is greater than 1000 ms), a touch duration D corresponding to the touch starting event is T3−T0, and a ratio of d of the touch duration D to the preset duration threshold (for example, 1000 ms) is determined as (T3−T0)/1000, a length of the progress bar displayed on the preset control on the basis of the ratio d (d is greater than 1) is still the maximum length of the progress bar, and a completion progress corresponding to the progress bar is 100%.

In some embodiments, first, in response to detecting a touch starting event for a preset control on a video playing page, a touch duration corresponding to the touch starting event is acquired, and then, the preset control is zoomed in on the video playing page in a zooming-in factor corresponding to the touch duration.

When the touch duration is a preset first duration, the zooming-in factor corresponding to the touch duration is maximum, the preset first duration being not greater than the preset duration threshold.

In the embodiment of the present disclosure, in response to detecting a touch starting event for a preset control on a video playing page, a touch duration corresponding to the touch starting event is acquired, and the preset control is zoomed in on the video playing page in a zooming-in factor corresponding to the touch duration. Different touch durations may respectively correspond to one zooming-in factor, for example, when the touch duration is 75 ms, its corresponding zooming-in factor is 1.2 times, then the preset control is zoomed in on the video playing page in 1.2 times an original size; when the touch duration is 150 ms, its corresponding zooming-in factor is 1.5 times, then the preset control is zoomed in on the video playing page in 1.5 times the original size; when the touch duration is 300 ms, its corresponding zooming-in factor is 2 times, then the preset control is zoomed in on the video playing page in 2 times the original size; and so on.

In the embodiment of the present disclosure, when the touch duration is the preset first duration, its corresponding zooming-in factor is maximum, and after the preset control is zoomed in on the video playing page in the maximum factor, even if the touch duration corresponding to the touch starting event increases, the preset control is still zoomed in in the maximum factor, wherein the preset first duration is not greater than the preset duration threshold.

For example, assuming that the preset first duration is preset to 300 ms, when the touch duration is 300 ms, its corresponding zooming-in factor (for example, 2 times) is a maximum zooming-in factor, at this time, the display for the preset control on the video playing page reaches the maximum, and when the touch duration is 1000 ms, the size of the preset control displayed on the video playing page remains unchanged in its maximum shape.

As shown in FIG. 2, it is a schematic diagram of a preset control display according to an embodiment of the present disclosure, wherein when a touch duration corresponding to a touch starting event is T1−T0, the touch duration corresponds to one zooming-in factor (for example, 1.2 times), and a preset control is zoomed in on a video playing page in 1.2 times an original size; when a touch duration corresponding to the touch starting event is T2−T0, at this time, the touch duration T2−T0 is a preset first duration, then a zooming-in factor (for example, 2 times) corresponding to the touch duration T2−T0 is maximum, and the preset control is zoomed in on the video playing page in 2 times the original size; when a touch duration corresponding to the touch starting event is greater than T2−T0, the size of the displayed preset control remains unchanged in its maximum shape (for example, in FIG. 2, the display of the preset control corresponding to the touch duration of 1000 ms and the display of the preset control corresponding to the touch duration of T3−T0).

In some embodiments, in response to a drag operation for the preset control, the preset control is moved and displayed on the video playing page on the basis of a drag trajectory corresponding to the drag operation.

In the embodiment of the present disclosure, when a drag operation for a preset control is received, the preset control may be move-displayed on the video playing page on the basis of a drag trajectory corresponding to the drag operation; for example, assuming that when a touch starting event for the preset control on the video playing page is detected, effect display for the preset control on the video playing page may be performed on the basis of a touch duration corresponding to the touch starting event; when a drag operation that a user drags upward for a position where the preset control is located is detected, the preset control may be move-displayed upwards on the video playing page along the drag trajectory, on the basis of a drag trajectory corresponding to the drag operation. That is to say, in the process of displaying the effect of the preset control on the basis of the touch duration, the user may also drag the preset control for movement display on the video playing page.

In some embodiments, in response to detecting a touch starting event for a preset control on a video playing page, on the basis of a touch duration corresponding to the touch starting event, not only display effect presentation for the preset control on the video playing page in the above embodiments can be achieved, but also interaction effect presentation for a target video played on the video playing page can be achieved.

Therefore, in the embodiment of the present disclosure, in response to detecting a touch starting event for a preset control on a video playing page, or when it is determined that a touch duration corresponding to the touch starting event reaches a preset second duration, a recommended object corresponding to the target video played on the video playing page is sprayed and presented from the preset control.

In the embodiment of the present disclosure, there may be various ways to trigger the spray presentation of the recommended object corresponding to the target video played on the video playing page from the preset control. Way 1: in response to detecting a touch starting event for a preset control on a video playing page, the recommended object corresponding to the target video played on the video playing page may be sprayed and presented from the preset control. The recommended object corresponding to the target video may comprise a pre-configured recommended object corresponding to the target video. For example, assuming that the recommended object corresponding to the target video is rainbow sugar, in response to detecting that a finger touches the preset control on the video playing page, a plurality of rainbow sugar objects in various colors and various forms may be sprayed and presented from the preset control in a form of physical particle spray.

Way 2: in response to detecting a touch starting event for a preset control on a video playing page, timekeeping is started, a start timestamp may be recorded as TO, and when it is determined that a touch duration (e.g., T1−T0) corresponding to the touch starting event reaches a preset second duration, the recommended object corresponding to the target video played on the video playing page may also be spray-presented from the preset control, wherein the preset second duration may be less than the preset duration threshold, or greater than or equal to the preset duration threshold.

In some embodiments, in response to detecting a touch starting event for a preset control on a video playing page, or when it is determined that a touch duration corresponding to the touch starting event reaches a preset third duration, a target video played on the video playing page is controlled to be played according to a preset playing mode, wherein the preset playing mode comprises fast playing, slow playing, pause, or reverse playing.

In the embodiment of the present disclosure, there may be various ways to trigger the controlling a target video to be played according to a preset playing mode. Way 1: in response to detecting a touch starting event for a preset control on a video playing page, the target video can be controlled to be played according to a preset playing mode, wherein the preset playing mode comprises preset fast playing, slow playing, pause, or reverse playing and the like for the target video.

Way 2: in response to detecting a touch starting event for a preset control on a video playing page, timekeeping is started, a start timestamp can be recorded as TO, and when it is determined that a touch duration (such as T2−T0) corresponding to the touch starting event reaches a preset third duration, the target video can also be controlled to be played according to a preset playing mode, wherein the preset third duration can be less than a preset duration threshold, or greater than or equal to the preset duration threshold.

In the embodiment of the present disclosure, on the basis of the spray presentation of the recommended object corresponding to the target video played on the video playing page from the preset control, and the feedback form of controlling the target video to be played according to the preset playing mode, the display effect after the touch starting event is triggered for the preset control on the video playing page is enriched, and the playability is improved.

The method further comprises S102: in response to detecting a touch ending event corresponding to the touch starting event, determining whether a time difference between the touch starting event and the touch ending event is less than a preset duration threshold.

In the embodiment of the present disclosure, the touch ending event may refer to an event corresponding to an operation that a finger leaves the video playing page; on the basis of the touch duration corresponding to the touch starting event for the preset control on the video playing page detected in the above S101, the preset control is displayed, and when it is detected that the finger leaves the video playing page (i.e., the touch ending event), a timestamp (for example, the timestamp is TO′) corresponding to the touch ending event is recorded, and it is determined whether the touch duration (for example, TO′−T0) corresponding to the touch starting event is less than a preset duration threshold, wherein the touch duration corresponding to the touch starting event comprises a time difference between the timestamp when the touch starting event is detected and the timestamp when the touch ending event is detected, and the preset duration threshold is the same as the value of the preset duration threshold preset in the above S101, for example, the preset duration threshold may be 1000 ms, 2000 ms, etc. When the touch ending event is detected, in response to determining that the touch duration is not less than the preset duration threshold, it is indicated that the touch duration reaches the standard, and a preset page can be jumped to.

The method further comprises S103: in response to determining that the time difference between the touch starting event and the touch ending event is not less than the preset duration threshold, jumping from the video playing page to a preset page corresponding to the target video.

In the embodiment of the present disclosure, on the basis of the comparison of the time difference between the touch starting event and the touch ending event with the preset duration threshold, it can be determined whether a condition for triggering a jump to a preset page corresponding to the target video is satisfied. The target video is a video played on the video playing page, for example, the target video may comprise an application splash advertisement video, any video in a video stream, and the like. The target video may correspond to one preset page, wherein the preset page is a landing page associated with content presented by the target video, for example, the preset page may comprise an interaction page for a recommended object corresponding to the target video, a virtual resource acquisition page for the recommended object corresponding to the target video, and the like.

In the embodiment of the present disclosure, in response to detecting the touch ending event corresponding to the touch starting event, in response to determining that the time difference between the touch starting event and the touch ending event is not less than the preset duration threshold, it is indicated that a continuous touch duration when the finger touches the video playing page has reached a requirement for a minimum standard duration, then an effect of successfully jumping to a preset page corresponding to the target video may be triggered; and if the time difference between the touch starting event and the touch ending event is less than the preset duration threshold, it is indicated that a continuous touch duration when the finger touches the video playing page does not meet the requirement for a minimum standard duration, and it is further reflected that the user is not interested in the target video played on the video playing page, so that at this time, the effect of successfully jumping to the preset page corresponding to the target video cannot be triggered, and at this time, the home page of the application can be directly entered.

In some embodiments, in response to detecting a touch ending event corresponding to the touch starting event, the display for the progress bar on the preset control is hidden.

In the embodiment of the present disclosure, in response to detecting that the finger leaves the video playing page, the display for the progress bar on the preset control may be hidden, for example, when a completion progress corresponding to the progress bar displayed inside the preset control is ag, where a may be any value from 0 to 100, in response to detecting a touch ending event corresponding to the touch starting event, display for the progress bar on the preset control may be directly hidden.

In some embodiments, in response to detecting a touch ending event corresponding to the touch starting event, the zoomed-in preset control is controlled to be zoomed out to the original size.

In the embodiment of the present disclosure, in response to detecting that the finger leaves the video playing page, the zoomed-in preset control may be controlled to be zoomed out to the original size, for example, durations corresponding to the finger leaving the video playing page may respectively correspond to one zooming-out factor, so that controlling the zoomed-in preset control to be zoomed out to the original size may be a process in which the preset control is gradually zoomed out to the original size.

In the embodiment of the present disclosure, in response to detecting the touch ending event corresponding to the touch starting event, on the basis of the time difference between the touch starting event and the touch ending event, it may be determined whether to jump to the preset page corresponding to the target video or directly enter the home page of the application. In a state of a poor network environment, when it jumps to the preset page corresponding to the target video or enters the home page of the application, a lagging phenomenon may occur; at this time, in order to reduce a bad experience brought to the user by the lagging phenomenon, in response to detecting the touch ending event corresponding to the touch starting event, one or more of the effects of hiding the display for the progress bar on the preset control, and controlling the zoomed-in preset control to be zoomed out to the original size, can be achieved, so that display is performed after loading of the preset page corresponding to the target video or the home page of the application is completed, thereby improving the sensory experience of the user to a certain extent.

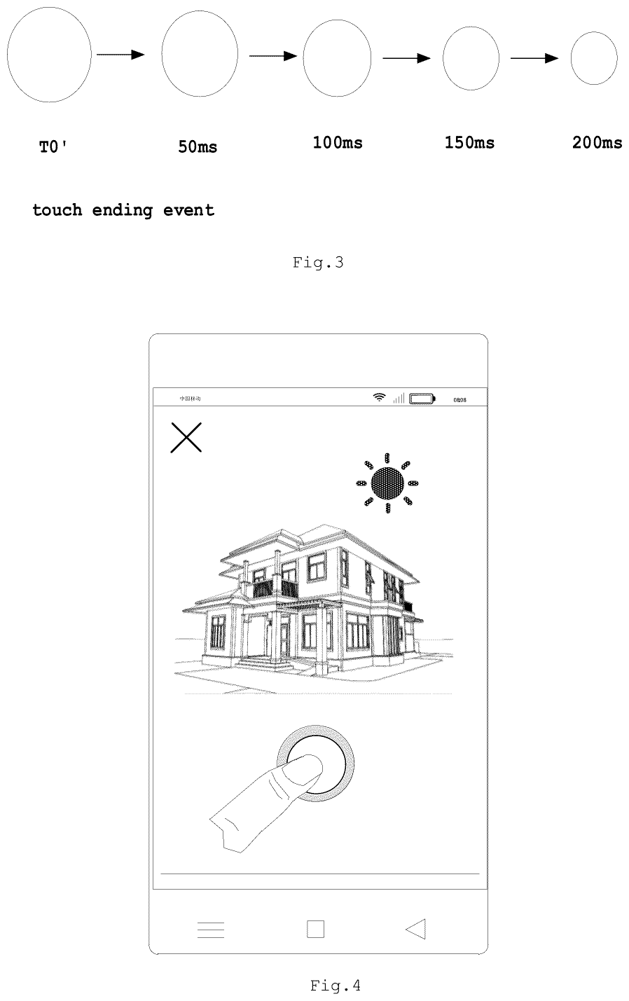

As shown in FIG. 3, it is a schematic diagram of another preset control display according to an embodiment of the present disclosure, wherein when a duration corresponding to a finger leaving a video playing page is 50 ms, it is possible to control the zoomed-in preset control to be zoomed out to a size a; when a duration corresponding to the finger leaving the video playing page is 100 ms, it is possible to control the zoomed-in preset control to be zoomed out to a size b; when a duration corresponding to the finger leaving the video playing page is 150 ms, it is possible to control the zoomed-in preset control to be zoomed out to a size c; and when a duration corresponding to the finger leaving the video playing page is 200 ms, it is possible to control the zoomed-in preset control to be zoomed out to an original size.

In the page control method according to the embodiment of the present disclosure comprises: first, in response to detecting a touch starting event for a preset control on a video playing page, on the basis of a touch duration corresponding to the touch starting event, display effect presentation for the preset control on the video playing page is performed, and interaction effect presentation for a target video played on the video playing page is performed, wherein the touch duration corresponding to the touch starting event comprises a time difference between a timestamp when the touch starting event is detected and a current timestamp, and the target video is played on the video playing page; then, in response to detecting a touch ending event corresponding to the touch starting event, it is determined whether a time difference between the touch starting event and the touch ending event is less than a preset duration threshold; and in response to determining that the time difference between the touch starting event and the touch ending event is not less than the preset duration threshold, it is jumped from the video playing page to a preset page corresponding to the target video. It can be seen that, according to the embodiment of the present disclosure, when the touch duration of the user on the preset control on the video playing page reaches the preset duration threshold, it is able to control page jump; in addition, before the touch ending event is received, by performing the effect display for the preset control on the basis of the touch duration corresponding to the touch starting event and performing interaction effect presentation for the target video, it is able to not only reduce the experience problems caused by the mis-touch on the screen, but also improve the user interaction experience by feeding back the touch effect to the user.

Based on the above embodiments, the present disclosure provides a specific application scenario for the page control method. Taking an example that the target video is a splash advertisement video, as shown in FIG. 4, it is a schematic diagram of a video playing page according to an embodiment of the present disclosure.

First, in response to detecting a touch starting event for a preset control on a video playing page for a splash advertisement video, on the basis of a touch duration corresponding to the touch starting event, display effect presentation for the preset control on the video playing page is performed, and interaction effect presentation for the splash advertisement video played on the video playing page is performed. The touch duration corresponding to the touch starting event comprises a difference between a timestamp when the touch starting event is detected and a current timestamp.

In the embodiment of the present disclosure, when a touch starting event for a preset control on a video playing page for a splash advertisement video is detected, timekeeping is started, a timestamp when the touch starting event is detected is recorded as TO, and assuming that a current timestamp is T1, a touch duration corresponding to the touch starting event is determined as T1−T0, and then on the basis of the touch duration, display effect presentation for the preset control on the video playing page can be performed.

As shown in FIG. 4, the preset control on the video playing page of the splash advertisement video is a circle control, a diameter of the displayed circle control is a preset maximum diameter, a progress bar displayed inside the circle control is also a preset maximum length, and a completion progress corresponding to the progress bar is 100%.

In the embodiment of the present disclosure, in response to detecting the touch starting event for the preset control on the video playing page, for the preset control on the video playing page for the splash advertisement video, in addition to the display effect presentation shown in FIG. 4, interaction effect presentation for the splash advertisement video played on the video playing page can be achieved; the corresponding specific presentation effect has been described in detail in the above disclosed embodiment, and thus is not repeated here.

Then, in response to detecting a touch ending event corresponding to the touch starting event, it is determined whether a time difference between the touch starting event and the touch ending event is less than a preset duration threshold.

In the embodiment of the present disclosure, in response to detecting a touch ending event for the preset control on the video playing page for the splash advertisement video, a corresponding current timestamp (for example, the timestamp is TO′) is recorded as a timestamp when the touch ending event is detected, a time difference between the touch starting event and the touch ending event, TO′−T0, is acquired, and it is determined whether TO′−T0 is less than the preset duration threshold, wherein the preset duration threshold may be set to 1000 ms.

In the embodiment of the present disclosure, in response to determining that TO′−T0 is not less than 1000 ms, it is indicated that the continuous touch duration of the finger touching the video playing page has reached a requirement for a minimum standard duration, then it jumps from the video playing page for the splash advertisement video to a preset page corresponding to the splash advertisement video, for example, the splash advertisement video is an advertisement video for a certain scenery spot, then the preset page corresponding to the splash advertisement video may be an interaction page for a recommended object corresponding to the splash advertisement video, for example, the preset page corresponding to the splash advertisement video may be a ticket purchasing page for the scenery spot, and the like.

In the embodiment of the present disclosure, in response to determining that TO′−T0 is less than 1000 ms, it is indicated that the continuous touch duration of the finger touching the video playing page does not meet the requirement for a minimum standard duration, then a home page of an application is directly entered from the video playing page for the splash advertisement video.

The page control method provided in the embodiment of the present disclosure comprises: first, in response to detecting a touch starting event for a preset control on a video playing page for a splash advertisement video, on the basis of a touch duration corresponding to the touch starting event, performing display effect presentation for the preset control on the video playing page, and performing interaction effect presentation for the splash advertisement video played on the video playing page, wherein the touch duration corresponding to the touch starting event comprises a difference between a timestamp when the touch starting event is detected and a current timestamp, then, in response to detecting a touch ending event corresponding to the touch starting event, determining whether a time difference between the touch starting event and the touch ending event is less than a preset duration threshold, and in response to determining that the time difference between the touch starting event and the touch ending event is not less than the preset duration threshold, jumping from the video playing page for the splash advertisement video to a preset page corresponding to the splash advertisement video. It can be seen that, according to the embodiment of the present disclosure, when the touch duration of the user for the preset control on the video playing page reaches the preset duration threshold, it is able to control page jump; in addition, before the touch ending event is received, by performing effect display for the preset control on the basis of the touch duration corresponding to the touch starting event and performing interaction effect presentation for the target video, it is able to not only reduce experience problems caused by a mis-touch on a screen, but also improve the user interaction experience by feeding back the touch effect to the user.

Based on the same inventive concept as the above embodiment, an embodiment of the present disclosure further provides a page control apparatus, referring to FIG. 5 which is a schematic structural diagram of a page control apparatus according to an embodiment of the present disclosure, the page control apparatus 500 comprising:
a presentation module 501 configured to, in response to detecting a touch starting event for a preset control on a video playing page, on the basis of a touch duration corresponding to the touch starting event, perform display effect presentation for the preset control on the video playing page, and perform interaction effect presentation for a target video played on the video playing page, wherein the touch duration corresponding to the touch starting event comprises a time difference between a timestamp when the touch starting event is detected and a current timestamp;
a determination module 502 configured to, in response to detecting a touch ending event corresponding to the touch starting event, determine whether a time difference between the touch starting event and the touch ending event is less than a preset duration threshold; and a jump module 503 configured to, in response to determining that the time difference between the touch starting event and the touch ending event is not less than the preset duration threshold, jump from the video playing page to a preset page corresponding to the target video.

In some embodiments, the presentation module 501 comprises:
a determination sub-module configured to, after the touch starting event for the preset control on the video playing page is detected, determine a ratio of the touch duration corresponding to the touch starting event to the preset duration threshold; and
a first presentation sub-module configured to, on the basis of the ratio, display a progress bar on the preset control on the video playing page, wherein a length of the progress bar is in direct proportion to the ratio, and a maximum length of the progress bar corresponds to the ratio of 1.

In some embodiments, the presentation module 501 comprises:
an acquisition sub-module configured to, after the touch starting event for the preset control on the video playing page is detected, acquire the touch duration corresponding to the touch starting event; and
a second presentation sub-module configured to zoom in the preset control on the video playing page, in a zooming-in factor corresponding to the touch duration, wherein the zooming-in factor corresponding to the touch duration is maximum when the touch duration is a preset first duration, the preset first duration being not greater than the preset duration threshold.

In some embodiments, the apparatus further comprises:
a hiding module configured to, when the touch ending event corresponding to the touch starting event is detected, hiding display for the progress bar on the preset control.

In some embodiments, the apparatus further comprises:
a zooming-out module configured to, when the touch ending event corresponding to the touch starting event is detected, control the zoomed-in preset control to be zoomed out to an original size.

In some embodiments, the apparatus further comprises:
a movement module configured to, in response to a drag operation for the preset control, on the basis of a drag trajectory corresponding to the drag operation, move-display the preset control on the video playing page.

In some embodiments, the presentation module 501 comprises:
a third presentation sub-module configured to, when the touch starting event for the preset control on the video playing page is detected, or when it is determined that the touch duration corresponding to the touch starting event reaches a preset second duration, spray-present, from the preset control, a recommended object corresponding to the target video played on the video playing page.

In some embodiments, the presentation module 501 comprises:
a playing sub-module configured to, when the touch starting event for the preset control on the video playing page is detected, or when it is determined that the touch duration corresponding to the touch starting event reaches a preset third duration, control the target video played on the video playing page to be played according to a preset playing mode, wherein the preset playing mode comprises fast playing, slow playing, pause, or reverse playing.

In the page control device provided in the embodiment of the present disclosure, first, in response to detecting a touch starting event for a preset control on a video playing page, on the basis of a touch duration corresponding to the touch starting event, display effect presentation for the preset control on the video playing page is performed, and interaction effect presentation for a target video played on the video playing page is performed, wherein the touch duration corresponding to the touch starting event comprises a time difference between a timestamp when the touch starting event is detected and a current timestamp, and then, in response to detecting a touch ending event corresponding to the touch starting event, it is determined whether a time difference between the touch starting event and the touch ending event is less than a preset duration threshold, and in response to determining that the time difference between the touch starting event and the touch ending event is not less than the preset duration threshold, it jumps from the video playing page to a preset page corresponding to the target video. It can be seen that, according to the embodiment of the present disclosure, when the touch duration of the user on the preset control on the video playing page reaches the preset duration threshold, it is able to control page jump; in addition, before the touch ending event is received, by performing effect display for the preset control on the basis of the touch duration corresponding to the touch starting event and performing interaction effect presentation for the target video, it is able to not only reduce experience problems caused by a mis-touch on a screen, but also improve the user interaction experience by feeding back the touch effect to the user.

In addition to the above method and apparatus, an embodiment of the present disclosure further provides a computer-readable storage medium having therein stored instructions which, when run on a terminal device, cause the terminal device to implement the page control method according to the embodiment of the present disclosure.

An embodiment of the present disclosure further provides a computer program product, comprising a computer program/instructions which, when executed by a processor, implement the page control method according to the embodiment of the present disclosure.

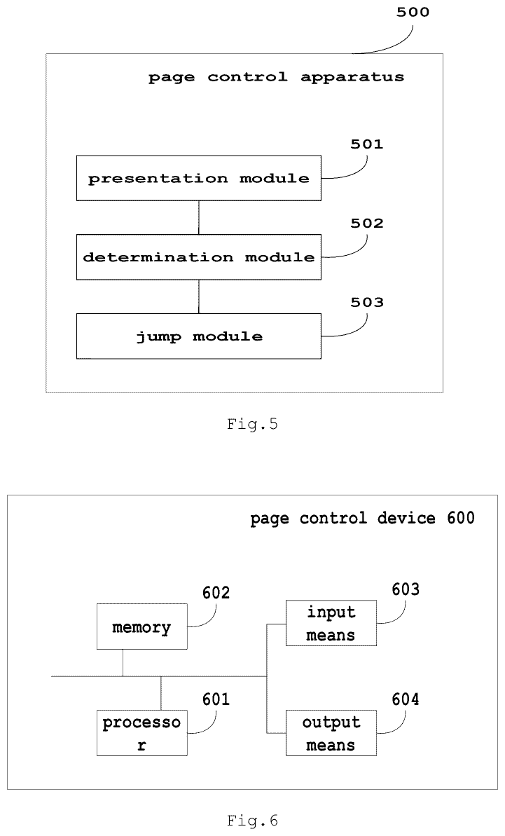

In addition, an embodiment of the present disclosure further provides a page control device 600, wherein referring to FIG. 6, the device may comprise:
a processor 601, a memory 602, an input means 603, and an output means 604. The number of processors 601 in the page control device may be one or more, wherein one processor is taken as an example in FIG. 6. In some embodiments of the present disclosure, the processor 601, the memory 602, the input means 603 and the output means 604 may be connected by a bus or other manners, wherein the connection by the bus is taken as an example in FIG. 6.

The memory 602 may be configured to store software programs and modules, and the processor 601 controls various functional applications and data processing of the page control device by running the software programs and modules stored in the memory 602. The memory 602 may mainly comprise a program storage area and a data storage area, wherein the program storage area may store an operating system, an application required for at least one function, and the like. Furthermore, the memory 602 may comprise a high-speed random access memory, or a non-volatile memory, for example, at least one magnetic disk storage device, flash memory device, or other volatile solid-state storage devices. The input means 603 may be configured to receive input number or character information and generate a signal input related to a user setting and function control of the page control device.

Specifically, in this embodiment, the processor 601 will, according to the following instructions, load an executable file corresponding to one or more processes of the application into the memory 602, and the processor 601 runs the application stored in the memory 602, thereby realizing various functions of the page control device.

It should be noted that, relational terms such as “first” and “second”, herein, are only used for distinguishing one entity or operation from another entity or operation without necessarily requiring or implying any such actual relation or order between these entities or operations. Moreover, the term “comprise”, “include”, or any other variation thereof, is intended to encompass a non-exclusive inclusion, such that a process, method, article, or device comprising a list of elements not only comprises those elements but also comprises other elements not expressly listed, or also comprises elements inherent to such a process, method, article, or device. Without more limitations, an element defined by a statement “comprising a . . . ” does not exclude the presence of another identical element in a process, method, article, or device that comprises the element.

The above only describes specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but conform to the widest scope consistent with the principles and novel features disclosed herein.

1. A page control method, comprising:
in response to detecting a touch starting event for a preset control on a video playing page, on the basis of a touch duration corresponding to the touch starting event, performing display effect presentation for the preset control on the video playing page, and performing interaction effect presentation for a target video played on the video playing page, wherein the touch duration corresponding to the touch starting event comprises a time difference between a timestamp when the touch starting event is detected and a current timestamp;
in response to detecting a touch ending event corresponding to the touch starting event, determining whether a time difference between the touch starting event and the touch ending event is less than a preset duration threshold; and
in response to determining that the time difference between the touch starting event and the touch ending event is not less than the preset duration threshold, jumping from the video playing page to a preset page corresponding to the target video.

2. The page control method according to claim 1, wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, determining a ratio of the touch duration corresponding to the touch starting event to the preset duration threshold; and
on the basis of the ratio, displaying a progress bar on the preset control on the video playing page, wherein a length of the progress bar is in direct proportion to the ratio, and a maximum length of the progress bar corresponds to the ratio of 1.

3. The page control method according to claim 1, wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, acquiring the touch duration corresponding to the touch starting event; and
zooming in the preset control on the video playing page, in a zooming-in factor corresponding to the touch duration, wherein the zooming-in factor corresponding to the touch duration is maximum when the touch duration is a preset first duration, the preset first duration being not greater than the preset duration threshold.

4. The page control method according to claim 2, further comprising:
in response to detecting the touch ending event corresponding to the touch starting event, hiding display for the progress bar on the preset control.

5. The page control method according to claim 3, further comprising:
in response to detecting the touch ending event corresponding to the touch starting event is, controlling the zoomed-in preset control to be zoomed out to an original size.

6. The page control method according to claim 1, further comprising:
in response to a drag operation on the preset control, on the basis of a drag trajectory corresponding to the drag operation, moving and displaying the preset control on the video playing page.

7. The page control method according to claim 1, wherein the, in response to detecting a touch starting event for a preset control on a video playing page is detected, performing interaction effect presentation for a target video played on the video playing page, comprises:
in response to detecting the touch starting event for the preset control on the video playing page, or in response to determining that the touch duration corresponding to the touch starting event reaches a preset second duration, spray-presenting, from the preset control, a recommended object corresponding to the target video played on the video playing page.

8. The page control method according to claim 1, wherein the, in response to detecting a touch starting event for a preset control on a video playing page, performing interaction effect presentation for a target video played on the video playing page, comprises:
in response to detecting the touch starting event for the preset control on the video playing page is detected, or in response to determining that the touch duration corresponding to the touch starting event reaches a preset third duration, controlling the target video played on the video playing page to be played according to a preset playing mode, wherein the preset playing mode comprises fast playing, slow playing, pause, or reverse playing.

9. The page control method according to, wherein the, in response to detecting a touch starting event for a preset control on a video playing page is detected, on the basis of a touch duration corresponding to the touch starting event, performing display effect presentation for the preset control on the video playing page, comprises performing one or more of:
displaying a color of the preset control, which is gradually darkened;
displaying a size of the preset control, which is gradually zoomed-in; and
displaying a progress bar on the preset control.

10. The page control method according to claim 2, wherein, the, in response to detecting the touch starting event for the preset control on the video playing page, determining a ratio of the touch duration corresponding to the touch starting event to the preset duration threshold, comprises:
determining the ratio of the touch duration corresponding to the touch starting event to the preset duration threshold according to a preset frequency.

11. (canceled)

12. A non-transitory computer-readable storage medium having therein stored instructions which, when running on a terminal device, cause the terminal device to implement a page control method comprising:
in response to detecting a touch starting event for a preset control on a video playing page, on the basis of a touch duration corresponding to the touch starting event, performing display effect presentation for the preset control on the video playing page, and performing interaction effect presentation for a target video played on the video playing page, wherein the touch duration corresponding to the touch starting event comprises a time difference between a timestamp when the touch starting event is detected and a current timestamp;
in response to detecting a touch ending event corresponding to the touch starting event, determining whether a time difference between the touch starting event and the touch ending event is less than a preset duration threshold; and
in response to determining that the time difference between the touch starting event and the touch ending event is not less than the preset duration threshold, jumping from the video playing page to a preset page corresponding to the target video.

13. A page control device, comprising: a memory, a processor, and a computer program stored on the memory and executable on the processor, the processor, when executing the computer program, implementing a page control method comprising:
in response to detecting a touch starting event for a preset control on a video playing page, on the basis of a touch duration corresponding to the touch starting event, performing display effect presentation for the preset control on the video playing page, and performing interaction effect presentation for a target video played on the video playing page, wherein the touch duration corresponding to the touch starting event comprises a time difference between a timestamp when the touch starting event is detected and a current timestamp;
in response to detecting a touch ending event corresponding to the touch starting event, determining whether a time difference between the touch starting event and the touch ending event is less than a preset duration threshold; and
in response to determining that the time difference between the touch starting event and the touch ending event is not less than the preset duration threshold, jumping from the video playing page to a preset page corresponding to the target video.

14-15. (canceled)

16. The non-transitory computer-readable storage medium according to claim 12,
wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, determining a ratio of the touch duration corresponding to the touch starting event to the preset duration threshold; and
on the basis of the ratio, displaying a progress bar on the preset control on the video playing page, wherein a length of the progress bar is in direct proportion to the ratio, and a maximum length of the progress bar corresponds to the ratio of 1.

17. The non-transitory computer-readable storage medium according to claim 12, wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, acquiring the touch duration corresponding to the touch starting event; and
zooming in the preset control on the video playing page, in a zooming-in factor corresponding to the touch duration, wherein the zooming-in factor corresponding to the touch duration is maximum when the touch duration is a preset first duration, the preset first duration being not greater than the preset duration threshold.

18. The non-transitory computer-readable storage medium according to claim 16, further comprising:
in response to detecting the touch ending event corresponding to the touch starting event, hiding display for the progress bar on the preset control.

19. The non-transitory computer-readable storage medium according to claim 17, further comprising:
in response to detecting the touch ending event corresponding to the touch starting event is, controlling the zoomed-in preset control to be zoomed out to an original size.

20. The page control device according to claim 13, wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, determining a ratio of the touch duration corresponding to the touch starting event to the preset duration threshold; and
on the basis of the ratio, displaying a progress bar on the preset control on the video playing page, wherein a length of the progress bar is in direct proportion to the ratio, and a maximum length of the progress bar corresponds to the ratio of 1.

21. The page control device according to claim 13, wherein in response to detecting a touch starting event for a preset control on a video playing page, on the basis of a touch duration corresponding to the touch starting event, performing display effect presentation for the preset control on the video playing page comprises:
in response to detecting the touch starting event for the preset control on the video playing page, acquiring the touch duration corresponding to the touch starting event; and
zooming in the preset control on the video playing page, in a zooming-in factor corresponding to the touch duration, wherein the zooming-in factor corresponding to the touch duration is maximum when the touch duration is a preset first duration, the preset first duration being not greater than the preset duration threshold.

22. The page control device according to claim 20, further comprising:
in response to detecting the touch ending event corresponding to the touch starting event, hiding display for the progress bar on the preset control.

23. The page control device according to claim 21, further comprising:
in response to detecting the touch ending event corresponding to the touch starting event is, controlling the zoomed-in preset control to be zoomed out to an original size.
